(19) United States
(12) Patent Application Publication
(10) Pub. No.: US 2007/0085872 A1
(43) Pub. Date: Apr. 19, 2007

(54) Printer and method of recording a low voltage error log

(75) Inventor: Mitsuaki Teradaira, Shiojiri-shi (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/583,217

(22) Filed: Oct. 18, 2006

(30) Foreign Application Priority Data
Oct. 18, 2005 (JP) JP 2005-302793

(51) Int. Cl. B41J 29/393

(52) U.S. Cl. 347/19

(57) ABSTRACT

A voltage monitor 21 monitors the power supply voltage V0 of the printer 1, and writes to the low voltage error log when the time t0 passed after the power supply voltage V0 drops to or below a threshold voltage V1 reaches a first time t1. If the voltage drops to a logic circuit reset voltage V2 before the elapsed time t0 reaches the first time t1, the low voltage error log is not recorded.

The present invention claims benefit from Japanese Application No. 2005-302793 filed on Oct. 18, 2005, which is hereby incorporated by reference in its entirety.

### BACKGROUND OF THE INVENTION

1. Technical Field

The present invention relates to a printer and a method of recording a low voltage error log.

2. Related Art

Errors occur during printer operation. The user must take some action when an error occurs, and recording a history of the errors that occur (an error log) can help handle errors efficiently.

Devices that have memory in the power supply device for recording an error log are also known from the literature. See, for example, Japanese Unexamined Patent Appl. Pub. 2002-325434.

Errors that occur in printers include errors that occur when the voltage is less than or equal to a predetermined threshold voltage (commonly referred to as “low voltage errors”). Low voltage errors do not occur frequently but can have major consequences in a printer, including, for example, causing mechanical problems and creating errors in data sent to or stored in the printer.

Printers therefore generally have a voltage monitoring device, and the voltage monitoring device constantly monitors the voltage at a particular part of the printer (such as the voltage supply). When the monitored voltage drops to or below a predetermined threshold level, the internal power supply that supplies power to the mechanical parts of the printer is shut down to protect the printer and the output ports are set to a safe mode. The main control circuits of the printer can still operate at this threshold voltage level, and can therefore implement these safety measures.

A record (such as the time and type of error) of the low voltage error is then recorded in an error log stored in the error log storage device of the printer. The error log storage device has limited capacity, and the number of records that can be stored is therefore limited.

The following problems that can result when storing the error log. When the printer voltage drops to the threshold voltage when the printer power is turned off during normal operation, the voltage monitoring device recognizes the voltage drop as a low voltage error and therefore writes a record of the low voltage error in the error log storage device. If a low voltage error is added to the error log every time the printer power turns off, the low voltage error log and records of other important errors that are the errors of interest become buried amongst spurious low voltage errors, and the advantage of maintaining an error log is lost.

Operation of the power on/off switch can obviously be monitored to prevent recording a low voltage error in the log when the power switch turns off, but this requires another part for monitoring power switch operation and is therefore undesirable because of the increase in the printer manufacturing cost.

### SUMMARY

The present invention solves this problem as described below.

A printer according to a first embodiment of the invention is a printer for recording a low voltage error log if a drop in voltage at a predetermined location to or below a threshold voltage is determined to be a low voltage error, wherein the voltage is externally supplied when a power switch is on, and the low voltage error log is recorded after a first time elapses. This first time is longer than the time required by the voltage to drop from the threshold voltage to a logic circuit reset voltage when the voltage drops in conjunction with the power switch turning off.

With a printer according to this first embodiment of the invention, nothing is recorded in the low voltage error log until after this first time passes from the time when the voltage drops to or below the threshold voltage. As a result, if the voltage drops to the logic circuit reset voltage or below while waiting for the first time to elapse from the time the voltage drops to or below the threshold voltage, operation ends without the low voltage error log being recorded. When most actual low voltage errors occur, the voltage does not drop to the logic circuit reset voltage by the time this first time elapses. As a result, actual low voltage errors are normally recorded in the low voltage error log storage device.

Low voltage errors that should be recorded in the low voltage error log are therefore reliably selected and recorded.

Preferably, this first time is set to a time that is longer than the time required for the voltage to drop from the first threshold voltage that is used to detect low voltage errors to the logic circuit reset voltage when the voltage drops because the power switch is turned off normally. When the voltage of an external power supply drops because the power switch is turned off, this embodiment of the invention reliably prevents the voltage drop from being logged in the low voltage error log stored in the error log storage device.

A printer according to a second embodiment of the invention is a printer for recording a low voltage error log if a drop in voltage at a predetermined location to or below a threshold voltage is determined to be a low voltage error, wherein the low voltage error log is recorded based on change over time in the voltage when the voltage drops to less than or equal to the threshold voltage.

The printer according to this embodiment of the invention simply monitors the change in voltage (because the printer already has a voltage monitoring device for monitoring low voltage errors) and does not require a sensor or other parts for monitoring the position of the on/off switch. Only errors that should normally be recorded in the error log storage device are therefore saved based on the time change in the voltage when the voltage drops to or below the threshold level, and the error log can therefore be used more effectively.

A method for recording a low voltage error log in a printer according to a third embodiment of the invention has steps of monitoring voltage at a predetermined location in the printer, measuring the time elapsed from when the voltage drops to less than or equal to the threshold voltage; and recording the low voltage error log after the elapsed time exceeds a first time.

With a printer according to this first embodiment of the invention, nothing is recorded in the low voltage error log until after this first time passes from the time when the voltage drops to or below the threshold voltage. As a result, if the voltage drops to the logic circuit reset voltage or below while waiting for the first time to elapse from the time the voltage drops to or below the threshold voltage, operation ends without the low voltage error log being recorded. When most actual low voltage errors occur, the voltage does not drop to the logic circuit reset voltage by the time this first time elapses.

Low voltage errors that should be recorded in the low voltage error log are therefore reliably selected and recorded.

A fourth embodiment of the invention is the method of the third embodiment of the invention wherein the first time is longer than the time required by the voltage to drop from the threshold voltage to a logic circuit reset voltage when the voltage drops in conjunction with the power switch turning off. When the voltage of an external power supply drops because the power switch is turned off, this embodiment of the invention reliably prevents the voltage drop from being logged in the low voltage error log stored in the error log storage device.

A method for recording a low voltage error log in a printer according to a fifth embodiment of the invention has steps of monitoring voltage at a predetermined location in the printer, and recording a low voltage error log based on time change in the voltage after the monitored voltage drops to or below the threshold voltage.

The low voltage error log recording method according to this embodiment of the invention simply monitors the change in voltage (because the printer already has a voltage monitoring device for monitoring low voltage errors) and does not require a sensor or other parts for monitoring the position of the on/off switch. As a result, the low voltage error log is not recorded when the voltage drops because the power switch is turned off even if the voltage drops to or below the threshold level. Only errors that should normally be recorded are therefore saved in the error log storage device, and the error log can be used more effectively.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a chart describing the voltage drop characteristic of a printer according to the present invention.

FIG. 2 is a block diagram showing the general arrangement of a printer according to the present invention.

FIG. 3 is a flow chart describing the operation of a printer according to the present invention.

### DESCRIPTION OF EMBODIMENTS

Elements of the present invention are described below with reference to the accompanying figures.

The printer has a voltage monitoring device for monitoring low voltage errors. This voltage monitoring device constantly monitors the voltage at a particular part of the printer. The part that is monitored is not specifically limited, but the power supply voltage is preferably monitored because voltage fluctuation is generally the greatest in the power supply

The voltage monitoring device can be an A/D converter or other common voltmeter.

When the voltage at the part being monitored in the printer drops to or below the predetermined threshold voltage, a low voltage error occurs and the control unit (logic circuit) of the printer shuts down the internal power supply applied to the motor and other driven parts or sets port output to a safe mode.

In a printer according to the present invention, the control unit creates a low voltage error log entry when a low voltage error occurs, and adds the error log entry to the error log stored in the flash memory or other device used as the error log storage device. The low voltage error entry contains at least data representing a low voltage error and data representing the time that the error occurred.

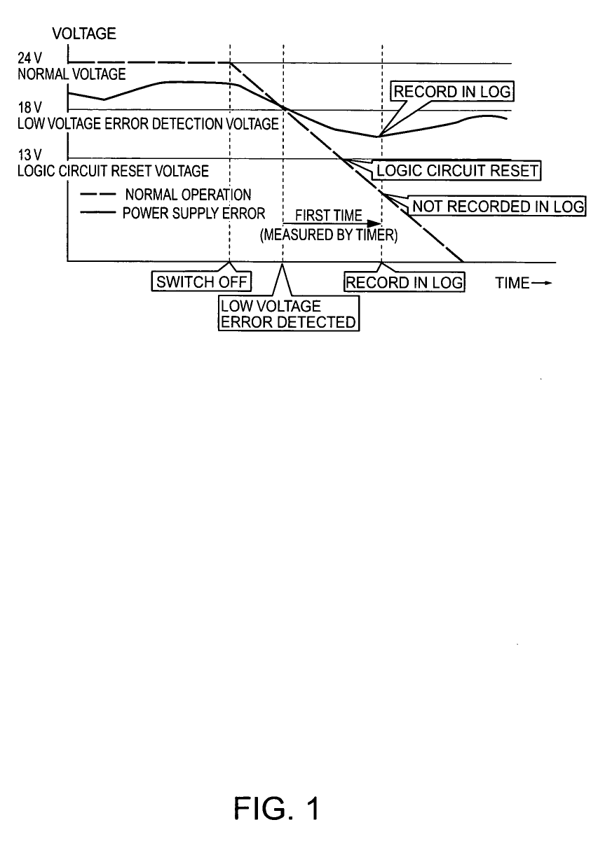

FIG. 1 shows the voltage drop when there is a fault in the power supply and when the power switch is turned off normally with the curves aligned so that the low voltage error is detected at the same time in both cases. The node in the printer where the voltage is monitored is the power supply line (24 V).

As will be known from these curves, when the power switch is turned off, the voltage starts dropping from the moment the switch turns off. In this embodiment of the invention 18 V is used as the threshold voltage for detecting a low voltage error. More specifically, a low voltage error is returned and the control unit (logic circuit) executes specific safety measures when the power supply voltage drops to 18 V or less. Low voltage error detection does not differentiate between errors resulting from a problem with the power supply and errors resulting from the switch turning off.

The logic circuit reset voltage is 13 V. When the power supply voltage drops to or below the logic circuit reset voltage, the logic circuit is reset and all printer operations are stopped.

In the example shown in FIG. 1, the logic circuit saves a low voltage error log entry in the error log storage device when a first time (such as 600 ms) passes after a low voltage error is detected.

As will be known from the example in FIG. 1, the logic circuit will not operate and therefore cannot write to the error log if the power supply voltage drops to or below the logic circuit reset voltage before this first time passes. As a result, no error log entries can be written to the error log storage device.

This first time can be desirably set according to the voltage drop characteristic of the printer when the power switch is turned off normally. The first time is longer than the time required for the power supply voltage to go from the threshold voltage to the logic circuit reset voltage when the power switch is turned off during normal operation.

As shown in FIG. 1, when the voltage drops due to a power supply error, the voltage does not drop to the logic circuit reset voltage even after dropping below the threshold voltage. As a result the logic circuit can write the low voltage error entry in the error log storage device after the first time has passed.

By saving low voltage error log entries when a predetermined time has passed after a low voltage error is detected, errors are not recorded in the low voltage error log if the logic circuit is reset before the predetermined time passes (such as when the voltage drops because the power switch was turned off normally).

When the voltage drops as a result of the power switch being turned off during normal operation, recording the voltage drop as a low voltage error in the error log can also be prevented based on the slope of the voltage drop when the low voltage error is detected. More specifically, because the voltage drop caused by turning the power switch off is substantially linear as shown in FIG. 1, the slope of this voltage drop in the printer can be stored as a reference slope, and this reference slope can be compared with the slope of the voltage change when a low voltage error is detected (when the power supply voltage goes to or below the threshold voltage). When the slopes match, a low voltage error is not recorded in the error log.

Recording a voltage drop caused by the power switch turning off during normal operation as a low voltage error in the error log can therefore be prevented by recording entries in the low voltage error log based on the voltage change over time.

A preferred embodiment of the invention is described below with reference to the accompanying figures.

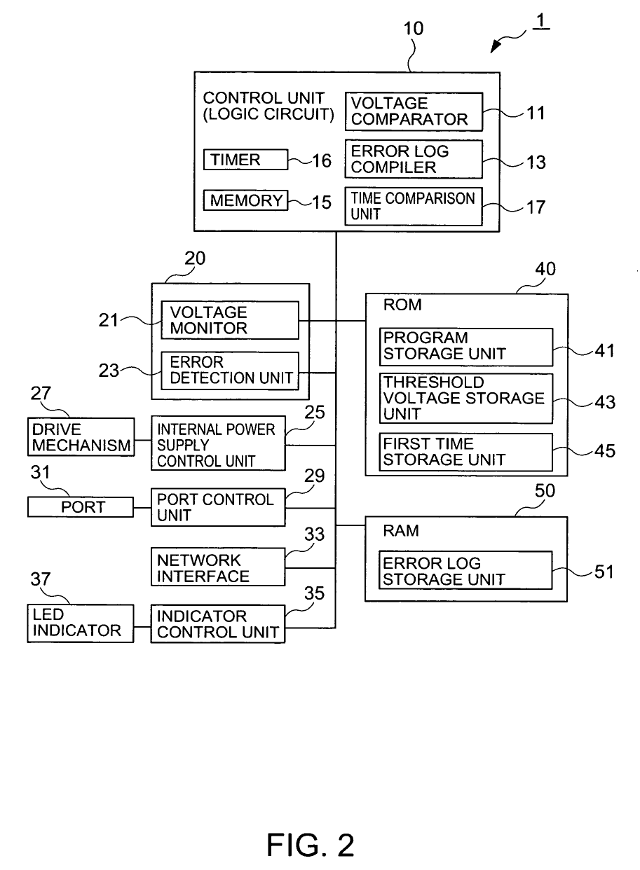

FIG. 2 is a block diagram showing the general arrangement of a printer according to this embodiment of the invention.

A printer 1 according to this embodiment of the invention has a control unit 10, detection unit 20, and memory devices 40 and 50.

The control unit 10 is a CPU or other logic circuit, and controls other parts of the printer based on a control program stored in the program storage unit 41 of the first memory device 40. The control unit 10 has a voltage comparator 11, error log compiler 13, and time comparison unit 17.

The detection unit 20 has a voltage monitor 21 and error detection unit 23. The voltage monitor 21 is a common voltmeter and monitors the voltage of the power supply line (not shown in the figure) of the printer 1. Low voltage errors can therefore be detected. The error detection unit 23 detects the occurrence of other errors that should be recorded in the error log of the printer 1. Examples of such other errors include an abnormal print head temperature, transmission function errors, and memory errors.

The internal power supply control unit 25 turns the internal power supply that supplies power to the motor, print head, and other drive mechanism 27 parts off based on the detected errors in order to protect the drive mechanism 27. The internal power supply control unit 25 also turns the internal power supply off when a low voltage error is detected.

The port control unit 29 operation is likewise controlled according to detected errors to reset the port 31 to a safe mode (such as the initialized state) as needed. When a low voltage error is detected, the port control unit 29 therefore sets the port 31 to the initialized state.

The network interface 33 connects to a general purpose communication device having a serial, parallel, USB, Ethernet, orother type of interface, and enables communicating with a host device. When an error occurs, the printer sends an error status report to the host. When a low voltage error occurs, the printer sends a nonrecoverable error status report and status data indicating that a low voltage error occurred to the server.

The indicator control unit 35 causes the LED indicator 37 to flash when an error is detected to report the error to the operator. When a low voltage error is detected, the indicator control unit 35 causes the LED indicator 37 to flash.

The read-only memory device 40 has a program storage unit 41, threshold voltage storage unit 43, and first time storage unit 45. The content stored in the memory device 40 defines the operating program of the control unit 10. The threshold voltage storage unit 43 stores the low voltage error detection voltage (threshold voltage) and the logic circuit reset voltage. The first time storage unit 45 stores the waiting time (first time), which starts from when a low voltage error is detected, for recording a low voltage error in the error log.

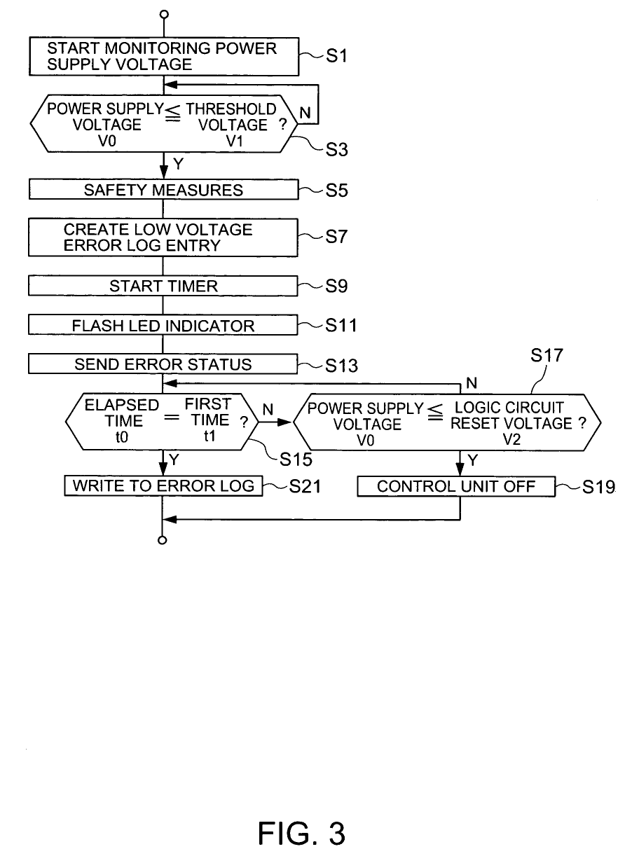

Operation of this printer 1 is described next with reference to the flow chart shown in FIG. 3.

The voltage monitor 21 starts monitoring the power supply voltage in step 1 in FIG. 3. The power supply voltage V0 is detected once every 20 ms in this embodiment of the invention.

In step 3 the voltage comparator 11 of the control unit 10 reads the threshold voltage V1 (18 V, the low voltage error detection voltage, in this embodiment) stored in the threshold voltage storage unit 43 and compares the threshold voltage V1 with the detected power supply voltage V0. If the power supply voltage V0 is less than or equal to threshold voltage V1, control goes to step 5. In step 5 the internal power supply control unit 25 turns the internal power supply off to interrupt the power supply to the drive mechanism 27 and the port control unit 29 sets the port 31 to the initialized state as safety measures.

In step 7 the error log compiler 13 creates a low voltage error log entry containing the content of the error (that the power supply voltage has dropped to a low voltage that is equal to or less than the threshold voltage in this example) and the time that the low voltage error occurred, and saves the log entry to the buffer memory 15 of the control unit 10.

In step 9 the control unit 10 starts the internal timer 16 to begin counting the time t0 elapsed since the low voltage error was detected.

The indicator control unit 35 is operated in step 11 to cause the LED indicator 37 to flash and thus report a low voltage error to the operator. Status data denoting a nonrecoverable error and low voltage error is then sent through the network interface 33 to the host in step 13.

The time comparison unit 17 of the control unit 10 reads and compares the first time t1 stored in the first time storage unit 45 with the elapsed time t0 measured by the timer 16 in step memory 15. Control goes to step 17 if the elapsed time t0 has not reached the first time.

The logic circuit reset voltage V2 (=13 V) and power supply voltage V0 are then compared in step 17.

If the power supply voltage V0 is less than or equal to the logic circuit reset voltage V2, the logic circuit of the control unit 10 turns off (step 19). The low voltage error log stored in the buffer memory 15 is therefore not stored in the memory device 50 and is deleted.

Note that step 17 and step 19 can be achieved by a circuit arrangement.

If the elapsed time t0 reaches the first time t1 (step 15 returns Yes), the control unit 10 writes the low voltage error log entry stored in buffer memory 15 to the error log storage unit 51 in the read/write memory device 50 (step 21).

Printer operation, error log recording, and error reporting to the operator and host when a low voltage error occurs are described above. When a different type of error occurs other measures are also taken according to the error and a record of the error is recorded in the error log storage unit 51. When the power switch turns off during normal operation and a voltage drop occurs, however, the invention does not record a low voltage error in the error log storage unit. As a result, only a log of actual errors is stored in the error log storage unit.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A printer for recording a low voltage error log if a drop in voltage at a predetermined location to or below a threshold voltage is determined to be a low voltage error, wherein:
the voltage is externally supplied when a power switch is on; and
the low voltage error log is recorded after a first time elapses, said first time being longer than the time required by the voltage to drop from the threshold voltage to a logic circuit reset voltage when the voltage drops in conjunction with the power switch turning off.

2. The printer described in claim 1, wherein the low voltage error log is recorded based on a rate of change in the voltage after the voltage drops to less than or equal to the threshold voltage.

3. The printer described in claim 2, wherein the low voltage error log is recorded when the slope of voltage change deviates from a predetermined slope after the voltage drops to less than or equal to the threshold voltage.

4. A low voltage error log recording method comprising steps of:
monitoring voltage in a printer to which a power supply voltage is externally supplied when a power switch is on;
measuring an elapsed time starting from when the monitored voltage drops to less than or equal to a threshold voltage; and
recording a low voltage error in an error log after a first time elapses, said first time being longer than a time required by the monitored voltage to drop from the threshold voltage to a logic circuit reset voltage when the voltage drops in conjunction with the power switch turning off.

5. The low voltage error log recording method described in claim 4, wherein the low voltage error log is recorded based on a rate of change in the voltage after the voltage drops to less than or equal to the threshold voltage.

6. The low voltage error log recording method described in claim 5, wherein the low voltage error log is recorded when the slope of voltage change deviates from a predetermined slope after the voltage drops to less than or equal to the threshold voltage.

7. The voltage error log recording method described of claim 5, further including resetting said elapsed time when said monitored voltage drops to less than a logic circuit reset voltage.

8. A printer comprising:
a voltage monitor that detects a measured voltage;
a logic circuit that compares said measured voltage to a threshold voltage, measures an elapsed time starting when said measured voltage drops below said threshold voltage, and records a low voltage error log entry if said elapsed time reaches a first time and said measured voltage is not less than or equal to a logic circuit reset voltage.
